(19) United States
(12) Patent Application Publication
(10) Pub. No.: US 2010/0232030 A1
(43) Pub. Date: Sep. 16, 2010

(54) VARIABLE FOCUS LENS

(75) Inventor: Christoph Dobrusskin, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/377,018

(22) PCT Filed: Jul. 31, 2007
(86) PCT No.: PCT/IB07/53013

§ 371 Date: Feb. 10, 2009

(30) Foreign Application Priority Data
Aug. 15, 2006 (EP) 06118921.3

(51) Int. Cl. G02B 3/12

(52) U.S. Cl. 359/666

(57) ABSTRACT

A variable focus lens (10) comprises a container having an interior chamber (16). An optical axis (24) extends through the chamber. A first fluid medium (18) and a second fluid medium (20) are disposed in the chamber. A meniscus (22) is arranged substantially perpendicular to the optical axis and between the first medium and the second medium in said chamber. The variable focus lens further comprises a meniscus control system for controlling a shape of the meniscus. The meniscus control system comprises a first control element (26) and a second control element (28, 30). The first control element is coupled to the meniscus and is moveable in a direction substantially parallel to the optical axis. The first control element and the second control element are configured to interact using an electric field or a magnetic field, thereby using proven and reliable techniques. Further, the interior chamber may be a closed chamber without any elements extending through the wall of the chamber. Hence, a chance of leakage of the fluid media from the chamber is reduced.

### FIELD OF THE INVENTION

The present invention relates to a variable focus lens, in particular to a lens comprising a first medium and a second medium in a chamber, wherein a shape of a meniscus between the first and the second medium is controllable.

### BACKGROUND OF THE INVENTION

A variable focus lens of the above-described kind is known from the prior art. The shape of the meniscus or interface determines the focal length of the lens. By changing the shape of the meniscus the focal length of the lens is changed. For accurate control of the focal length it is required that the shape of the meniscus is accurately controlled.

A number of techniques for control of the meniscus have been proposed in the prior art. For example, it is known to use an electrowetting technique. WO 2005/096028 A proposes to use a piezoelectric actuator to change a pressure of one of the first medium and the second medium for moving the meniscus. JP 2004-233945 discloses to control an amount of the first medium and an amount of the second medium present in the lens and thereby controlling a shape of the interface between the first and the second medium.

Electrowetting has the disadvantage that it is difficult to utilize. The electrowetting principle is sensitive to the selected fluids and operating temperature conditions. Consequently, they may not be generally applicable. Controlling an amount of fluid requires a pump device. A pump device however may be technically complicated and difficult to control, considering the required size of the pump device, and such a pump device is sensitive to malfunctioning.

It is desirable to have a variable focus lens not having the above-mentioned disadvantages. Thus, it is an object to provide an alternative variable focus length.

### SUMMARY OF THE INVENTION

In an aspect, the present invention provides a variable focus length according to claim 1. The lens comprises a container having an interior chamber, an optical axis of the lens extending through the chamber. In the chamber, a first fluid medium and a second fluid medium are disposed. A meniscus is arranged between the first medium and the second medium in the chamber. The chamber is completely filled with the first medium and the second medium. Consequently, the volume of the first medium and the volume of the second medium cannot change. The meniscus keeps the first medium and the second medium separated. The lens further comprises a meniscus control system for controlling a shape of the meniscus. The shape of the meniscus determines the focal length of the variable focus lens. The meniscus control system comprises a first control element and a second control element. The first control element is coupled to the meniscus and is moveable in a direction substantially parallel to the optical axis. Since the volume of the first fluid medium and the second fluid medium cannot change, moving the first control element results in a changing shape of the meniscus. The first control element and the second control element are configured to interact using an electric field or a magnetic field.

In an embodiment, a magnetic field is used for interaction between the first and the second control element. At least one of the first and the second control element needs to be a controllable magnetic element, whereas one of the first and the second control element may be a magnetic element. A magnetic force exerted between the first control element and the second control element results in a movement of the first control element and thereby a change of the shape of the meniscus.

The controllable magnetic element may be a coil operatively coupled to a power source. When a current flows through the coil, a magnetic field is generated. The strength of the magnetic field depends on the amount of current flowing through the coil. Thus the strength of the magnetic field is controllable by control of the current.

A person skilled in the art understands that the force between the first control element and the second control element may as well be resulting from an electric field. The person skilled in the art readily understands how to design an embodiment in which an electric field is used for interaction between the first control element and the second control element.

In an embodiment, the second control element is arranged outside the chamber. In such an embodiment, no electrical connection needs to be arranged inside the chamber. In particular, the first control element may be a magnetic element and the second control element may be a controllable magnetic element. In such an embodiment, only passive elements are arranged in the chamber and the active elements are arranged outside the chamber.

In an embodiment, the first control element is arranged near an inner wall of the chamber. In such an embodiment guiding means may be provided between the first control element and the inner wall for a smooth movement of the first control element. Further, sealing means may be provided between the first control element and the inner wall of the chamber for keeping the first fluid medium and the second fluid medium separated.

### BRIEF DESCRIPTION OF THE DRAWINGS

Hereinafter, the present invention is elucidated in more detail with reference to the appended drawing showing non-limiting embodiments, wherein

FIG. 1 schematically shows an embodiment of a variable focus lens according to the present invention in a first state; and

FIG. 2 schematically shows the embodiment of a variable focus lens according to FIG. 1 in a second state.

### DETAILED DESCRIPTION OF THE EMBODIMENT

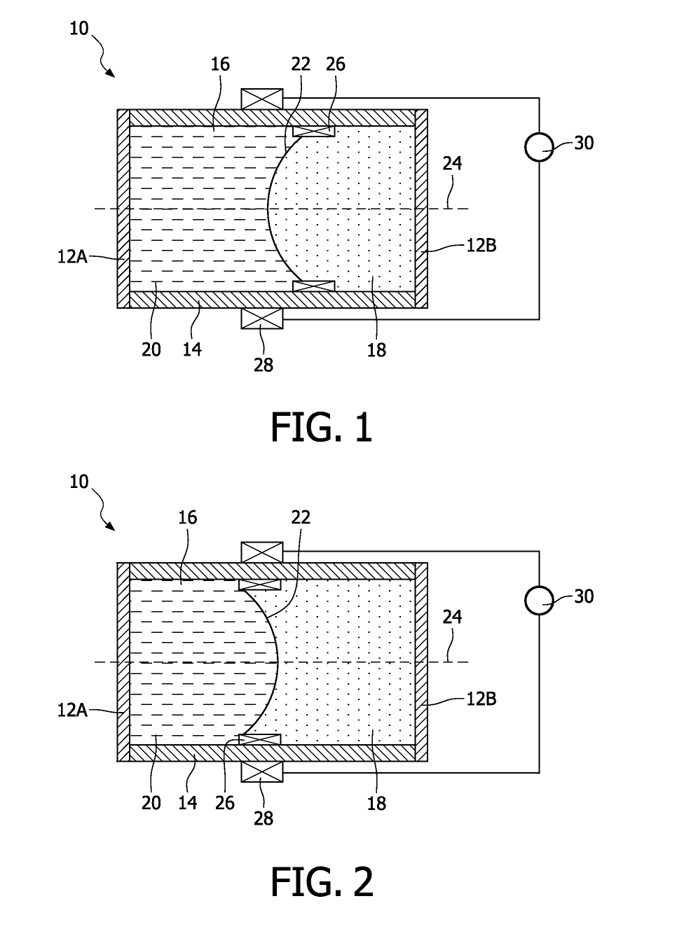

In the drawing, like reference numerals refer to like components and/or features. FIG. 1 shows an embodiment of a variable focus lens 10 according to the present invention. The lens 10 comprises a container having first walls 12A, 12B and a second wall 14. The first walls 12A, 12B are at least partly transparent. The walls 12A, 12B, 14 of the container define a chamber 16. In the chamber 16 a first fluid medium 18 and a second fluid medium 20 are disposed. The first fluid medium 18 and the second fluid medium 20 are substantially transparent, if the lens 10 is only to function as a lens 10. However, if the lens 10 is also to function as a filter, a transmissivity of the first and/or second fluid medium 18, 20 may be selected corresponding to the desired filter effect. Between the first medium 18 and the second medium 20 a meniscus 22 is arranged, keeping the first medium 18 and the second medium 20 separated. An optical axis 24 extends through the chamber 16 and is substantially perpendicular to the meniscus 22.

At an outer perimeter of the meniscus 22, the meniscus is coupled to a first control element 26, which comprises a magnetic element. A coil 28 of a second control element is arranged at an outer perimeter of the second wall 14. The second control element further comprises an electrical power source 30 coupled to the coil 28. When a current is flowing through the coil 28, a magnetic field is generated. Thus, a magnetic force is generated between the magnetic element of the first control element 26 and the coil 28. Depending on the magnetic force the first control element 26 may move substantially parallel to the optical axis 24 and along the second wall 14. To ensure a smooth movement, guiding means may be provided between the second wall 14 and the first control element 26. To keep the first fluid medium 18 and the second fluid medium 20 separated, sealing means may be provided between the second wall 14 and the first control element 26.

In FIG. 1 the meniscus 22 of the lens 10 is illustrated in a first state, in which a curvature of the meniscus 22 is convex (as seen in relation to the first control element 26). In FIG. 2, the lens 10 is in a second state, in which the first control element 26 has moved compared to the first state as illustrated in FIG. 1. As the volume of the first fluid medium 18 and the second fluid medium 20 cannot change, the shape of the meniscus 22 changes, when the first control element 26 moves. In the second state (FIG. 2) the meniscus 22 is concave with respect to the first control element 26.

It is noted that with an elastic meniscus 22, virtually any position of the first control element 26 can be used. If the meniscus 22 is not elastic, there are two positions of the first control element 26, in which the meniscus 22 is tightened (one convex, one concave).

A lens effect of the variable focus lens 10 results from the curvature (shape) of the meniscus 22. Thus, changing the shape of the meniscus 22 changes the focal length of the lens 10. The actual focal length of the lens 10 further depends on a difference in refractive index of the first fluid medium 18 and the second fluid medium 20.

Although detailed embodiments of the present invention are disclosed herein, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

Further, the terms and phrases used herein are not intended to be limiting; but rather, to provide an understandable description of the invention. The terms “a” or “an”, as used herein, are defined as one or more than one. The term another, as used herein, is defined as at least a second or more. The terms including and/or having, as used herein, are defined as comprising (i.e., open language). The term coupled, as used herein, is defined as connected, although not necessarily directly, and not necessarily wiredly.

1. Variable focus lens (10) comprising
a container having an interior chamber (16), an optical axis (24) extending through the chamber;
a first fluid medium (18) and a second fluid medium (20) disposed in said chamber;
a meniscus (22) arranged substantially perpendicular to said optical axis and between the first medium and the second medium in said chamber; and
a meniscus control system for controlling a shape of the meniscus,
wherein the meniscus control system comprises a first control element (26) and a second control element (28, 30), the first control element being coupled to the meniscus and being moveable in a direction substantially parallel to the optical axis, the first control element and the second control element being configured to interact using an electric field or a magnetic field.

2. Variable focus lens according to claim 1, wherein the first control element and/or the second control element comprises a controllable magnetic element for generating a magnetic field in order to move the first control element.

3. Variable focus lens according to claim 1, wherein one of the first control element and the second control element comprises a magnetic element and the other one of the first control element and the second control element comprises a controllable magnetic element for generating a magnetic field in order to move the first control element.

4. Variable focus lens according to claim 1, wherein the second control element is arranged outside the chamber.

5. Variable focus lens according to claim 2, wherein the controllable magnetic element is a coil (28) operatively coupled to a power source (30).

6. Variable focus lens according to claim 1, wherein the first control element is arranged near an inner wall of the chamber.

7. Variable focus lens according to claim 6, wherein guiding means are provided between the first control element and the inner wall of the chamber.

8. Variable focus lens according to claim 6, wherein sealing means are provided between the first control element and the inner wall of the chamber.
